(19) United States
(12) Patent Application Publication
(10) Pub. No.: US 2020/0113756 A1
(43) Pub. Date: Apr. 16, 2020

(54) STEERING ARRANGEMENT FOR A WHEELCHAIR

(71) Applicant: Reto Togni, Zürich (CH)

(72) Inventor: Reto Togni, Zurich (CH)

(21) Appl. No.: 16/626,321

(22) PCT Filed: Jun. 19, 2018
(86) PCT No.: PCT/EP2018/066237

§ 371 Date: Dec. 24, 2019

(30) Foreign Application Priority Data
Jun. 21, 2017 (GB) 1709932.6

(51) Int. Cl. A61G 5/10; A61G 5/02; A61G 5/12

(52) U.S. Cl. CPC A61G 5/1051; A61G 5/1054; A61G 5/122; A61G 5/02

(57) ABSTRACT

A wheelchair (1) is described which has two large propulsion wheels (5) for manually propelling the wheelchair, and a steering arrangement comprising a steering bar (8) on which are mounted smaller wheels (6). The small wheels may be free pivotable, as castors, or they may be locked by locking pins (12). A back-rest (4) can be tilted or rotated in a lateral plane about an axis (4′) by the user leaning his or her upper body to the left or the right. Movement (19) of the back-rest is transmitted by lever (20) and Bowden cable (21) to the steering bar (8). In this manner, the wheelchair (1) may be steered by the user leaning to the left or right.

The invention relates to steering arrangements for vehicles, and in particular, but not exclusively, to steering arrangements for manually-propelled wheelchairs.

### BACKGROUND OF THE INVENTION

A vehicle such as a wheelchair typically has four wheels: two large propulsion wheels mounted on an axle underneath the seat and two stabilisation wheels forward or aft of the propulsion wheels. The wheels are arranged such that the centre of gravity of the wheelchair when the user is seated is between the two pairs of wheels.

The propulsion wheels may be driven by motor or manually by the user. In order to improve manoeuverability of the wheelchair, the stabilisation wheels may be configured to pivot freely, so that the wheelchair can be manoeuvered around tight corners, for example. By contrarotating the propulsion wheels, the wheelchair can be rotated on its axis. Steering such a wheelchair is only possible if the user is able to manually control both propulsion wheels. For users with only one arm available for propelling the wheelchair, this kind of steering arrangement is impracticable.

### PRIOR ART

U.S. Pat. No. 5,028,064 describes a racing wheelchair in which the user steers a single trailing wheel. Embodiments are described in which a harness, or arm-straps, are used so that the user can steer by twisting his or her upper body. A tilting seat is disclosed; when travelling at speed, the user can shift his or her weight to accommodate the cornering force, thereby tilting the seat and steering the wheel. The seat-tilting embodiment has the disadvantage that is not suitable for steering the wheelchair at low speeds, when the cornering forces are negligible. To operate the seat-tilting manually, the user would need to have some purchase against the frame of the wheelchair, for example using his or her arms, in order to exert enough force to tilt the seat.

British patent GB272141 describes an arrangement in which a steered wheel is controlled by a twisting movement of the user's back. Such a movement is unnatural and uncomfortable for the user, and may not be possible for some wheelchair users.

### BRIEF DESCRIPTION OF THE INVENTION

The invention aims to address the above and other disadvantages with the prior art by providing a vehicle, such as a wheelchair, according to claim 1. Further variants of the invention are set out in the dependent claims and in the following description. By enabling the user to steer by tilting his or her torso or upper body relative to the seat, the steering can be controlled even at low speeds, and provides a more natural and comfortable movement than the twisting movement known in the prior art.

### DETAILED DESCRIPTION OF THE INVENTION

The invention will now be described in detail with reference to the drawings, in which:

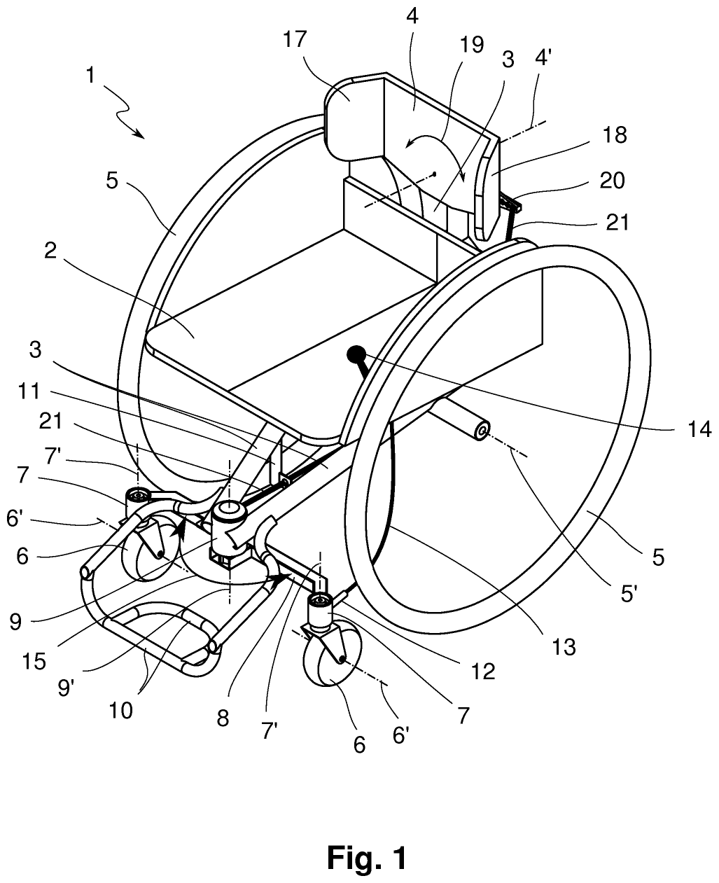

FIG. 1 shows in schematic view an orthographic projection of an example of a wheelchair according to the invention.

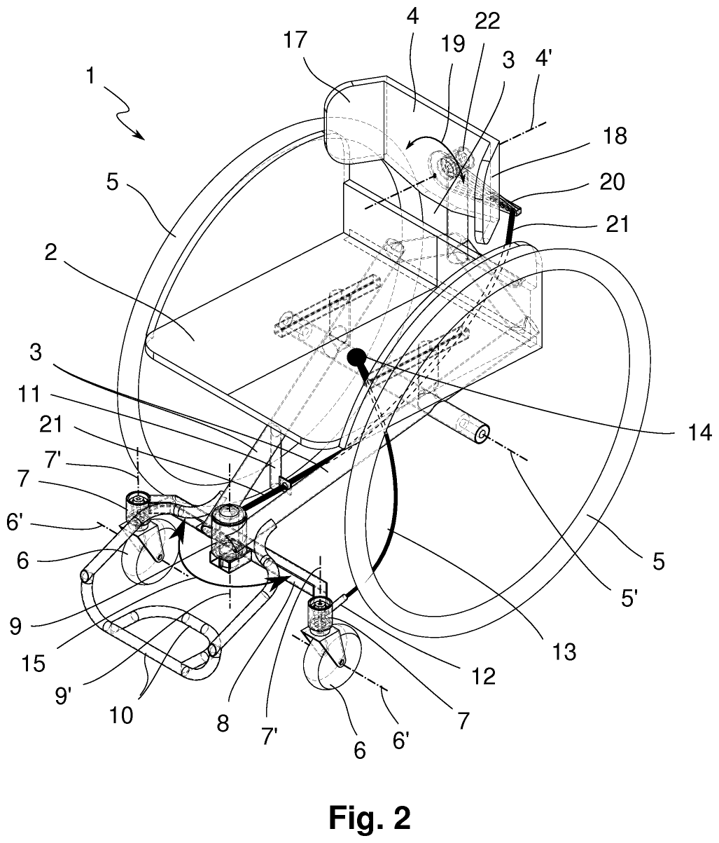

FIG. 2 shows a transparency view of the wheelchair of FIG. 1.

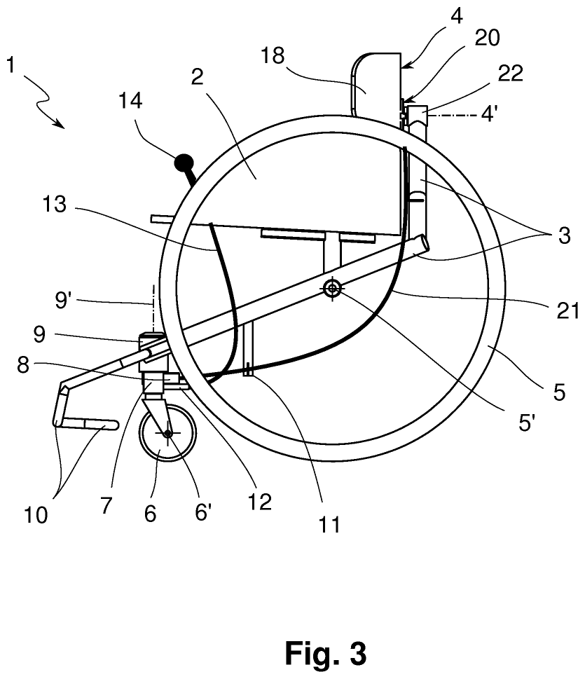

FIG. 3 shows a schematic side elevation of the wheelchair of FIG. 1.

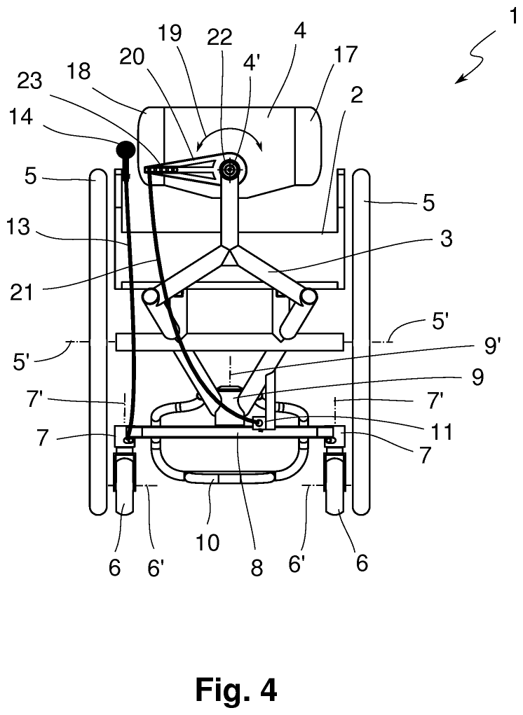

FIG. 4 shows a schematic rear elevation of the wheelchair of FIG. 1.

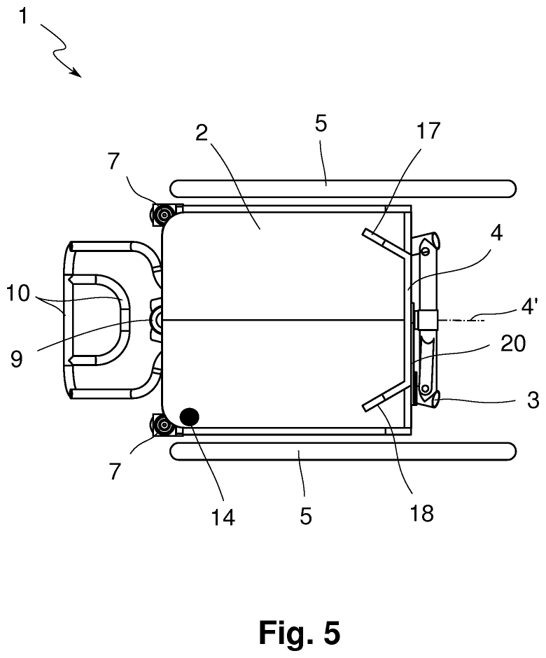

FIG. 5 shows a schematic plan view of the wheelchair of FIG. 1.

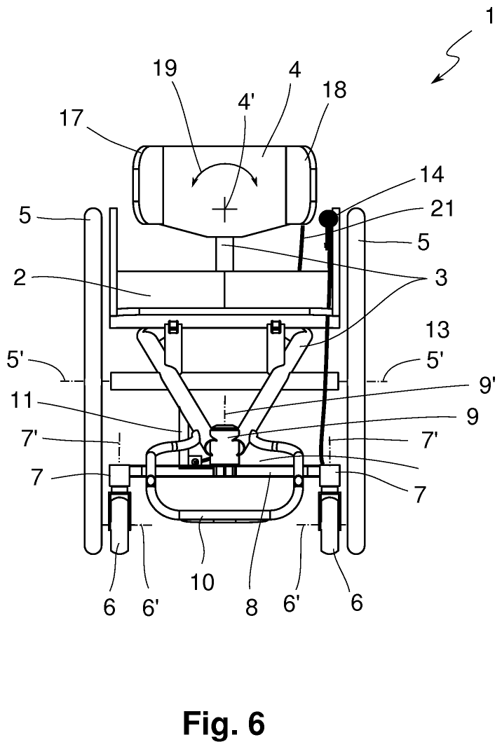

FIG. 6 shows a schematic front elevation of the wheelchair of FIG. 1.

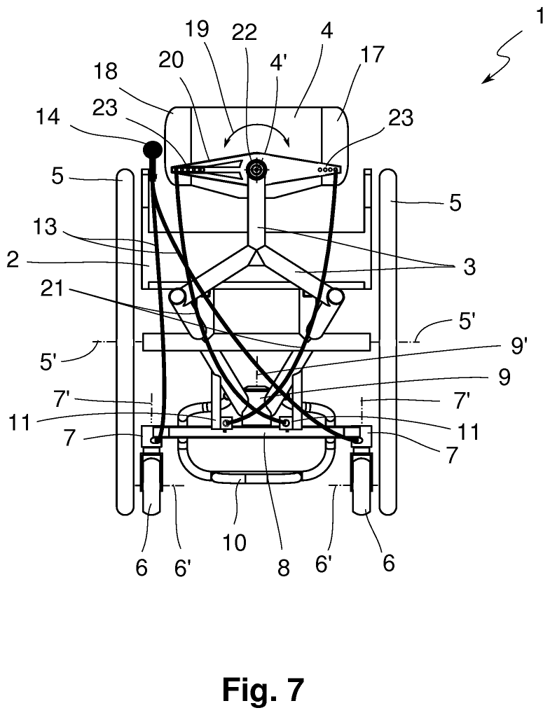

FIG. 7 shows a schematic rear view of an adapted variant of the wheelchair of FIG. 1.

Note that the drawings are intended merely as illustrations of example embodiments of the invention, and are not to be construed as limiting the scope of the invention. Where the same reference numerals are used in different drawings, these reference numerals are intended to refer to the same or corresponding features. However, the use of different reference numerals should not necessarily be taken as an indication that the referenced features are dissimilar.

FIGS. 1-6 show various views of an example of a wheelchair according to the invention. The wheelchair 1 has two large propulsion wheels 5 arranged to rotate around an axis 5′, two small, castor-type wheels 6, each arranged to rotate around a rotation axis 6′. The spokes of the large wheels 5 have been omitted from the figures for clarity. The castor wheels are mounted on a steering bar 8 by pivot joints 7, which are each controllably free to pivot around a vertical pivot axis 7′. The steering bar 8 is in turn connected to the frame 3 of the wheelchair 1 by means of a pivot joint 9, such that the steering bar 8 can rotate about vertical pivot axis 9′ as indicated by arrow 15.

The wheelchair 1 comprises a footrest 10 and a seat 2 which are connected substantially rigidly to the frame 3. Back-rest 4 is connected to the frame 3 by means of a pivot joint 22, such that the back-rest can rotate or tilt about pivot axis 4′ with a movement indicated by arrow 19. The back-rest has two engagement projections or wings 17, 18, which are adapted to engage with the sides of the user's torso when seated in the seat 2. The back-rest is provided with a lever arm 20 which, when tilted or rotated, actuates a connecting linkage 21, such as a Bowden cable, which is connected so as to move the steering bar 8 as indicated by the arrow 15. In this way, the tilting or rotating movement 19 of the back-rest 4 is converted into a change 15 in orientation of the steering. A fixed mounting point 11 is provided for the actuator cable 21. The mounting point 11 can act as a basis against which the actuator cable 21 exerts the force necessary to rotate the steering bar 8. The linkage 21 may be a mechanical one, such as the cable illustrated, or it may be partially mechanical, for example with a position or tilt sensor on the back-rest, a servo-actuator to actuate the movement of the steering, and a communications link such as a wireless, wired or optical link between the sensor and the servo.

In the illustrated example, the castor wheels 6 are operable in a free-pivoting mode, in which the wheels 6 are free to pivot around pivot axis 7′. They are also operable in a locked mode, in which the wheels 6 are locked into a fixed orientation about pivot axis 7′ and relative to the steering bar 8. The locking or free modes can be selected using a locking control means, which can include, for example, a lever 14 and cable 13 which pulls a spring-loaded pin 12 out of locking holes in the pivot 7.

When the user wishes to manoeuvre the wheelchair by manually operating the propulsion wheels 5, the wheels 6 can be unlocked using the locking actuation means 13, 14, thereby allowing them to pivot freely as castors. When the user instead wishes to steer using the tilting back-rest 4, he or she can engage the locking mode so that the pivot position of at least one of the wheels 6 is fixed relative to the steering bar 8. In this mode, the wheelchair can be propelled using either or both of the propulsion wheels 5 (for example using one or both hands), while the steering is done by leaning to left or right.

When in locked mode, the wheelchair 1 can thus be operated using only one arm. This is particularly useful for example when travelling along a surface which has a camber or lateral incline. Pavements and walkways are often cambered or inclined to promote water run-off. However, this kind of surface is difficult for a traditional wheelchair to travel along, as it requires constant steering adjustment to correct for the sideways drift due to the slanting surface. The wheelchair of the invention makes it possible for a user to propel the wheelchair with one arm while making the necessary steering adjustments by leaning to the left or right with his or her upper body.

In FIGS. 1 to 6, an arrangement is shown in which only one of the wheels 6 has a lockable pivot 7. A more preferable arrangement is shown in FIG. 7, which shows two wheels 6 lockable. In the example in FIG. 7, the two wheels 6 are lockable by a common locking actuation means 13, 14.

It should be noted that the steering arrangement shown in the example illustrations is one of several which can be contemplated to be actuated by the user leaning his or her torso to left or right. A single steerable wheel could be used, for example, with or without a steering bar, coupled by a suitable linkage to the tilting back-rest 4.

The steerable wheels 6 are illustrated as forward of the propulsion wheels 5. In an alternative embodiment, the steerable wheel(s) 6 are located aft of the propulsion wheels 5.

The rotating back-rest movement 19 is one of several movements which can be used to convert the lateral leaning movement of the user into steering actuation movement 15. Laterally-slidable back-rest projections can be used in an alternative embodiment, for example. Other mechanical displacements may also be used which permit a lateral lean of the user's torso to be translated into a steering actuation movement in eg the actuator cable 13.

As can be seen in FIGS. 4 and 7, the actuator horn 20 may be provided with various attachment points 23 for actuation cable 21, at different distances from the pivot axis 4′. A similar range of different attachment points (not illustrated) may be provided on the steering bar 8. By selecting an attachment point 23 on the actuator horn 20 and/or an attachment point on the steering bar 8, it is possible to vary the steering sensitivity. Advantageously, the steering sensitivity can be configured such that a tilt range of 0 to 15° of the back-rest 4 is translated to a steering radius range of straight ahead down to 0.5 m. More preferably, the steering sensitivity is configured such that a tilt range of 0 to 10° of the back-rest 4 is translated to a steering radius range of straight ahead down to 0.8 m. A tilt of the user's back in the range 3° to 10° is preferably translated into a steering radius in the range 0.7 m to 5 m.

The back-rest pivot axis 4′ is preferably aligned with the natural bending point of the user's back. In this case, the tilt angle of the back-rest will be substantially the same as the tilt angle of the user's back. The axis 4′ may advantageously be positioned at about 12 cm-18 cm above the sitting surface of the seat 2. Alternatively, the pivot axis 4′ may be positioned higher or lower than this range, depending on the lateral flexibility characteristics of the user's spine. The pivot axis 4′ may alternatively be located below the level of the sitting surface, such that the leaning angle of the user's torso translates into a smaller tilting angle of the back-rest. The height of the back-rest 4, the back-rest protrusions 17, 18 and/or of the back-rest pivot 4′ may advantageously be adjustable, so that they can be customised to the leaning ability of a particular user.

The small wheels 6 are configured to pivot like castors when not in locked mode. When in locked mode, they form, thanks to their trailing configuration relative to the steering bar, and thanks to the trailing configuration of the steering bar 8 relative to the pivot 9, a self-centering steering geometry. When the user does not lean sideways, the wheelchair will tend to go straight ahead.

FIG. 7 shows how, instead of the push-pull type actuator cable 21 illustrated in FIGS. 1 to 6, two pull cables can be used, for example with a suitably adapted actuator horn 20, such that one cable 21 pulls the steering bar 8 one way and the other cable 21 pulls the steering bar 8 the other way.

While the invention has been described with reference to a manually-propelled wheelchair, it may also find application in electrically-propelled wheelchairs or other types of steered vehicle, which can be adapted so that a tilting of the user's torso relative to the seat in which he or she is sitting is converted into a steering control movement of the steering. For example, a steerable sled may be configured to be steerable using the steering arrangement described above for controlling the steering of a ski or sled runner instead of the steerable wheel(s). The driver's seat of a car, or the pilot's seat of an aircraft may be equipped with a back-rest arrangement as described above, adapted for controlling the steering or flight controls.

1. A wheelchair comprising a seat, one or more steerable wheels and actuation means for controlling the steering position of the one or more steerable wheels, wherein the actuation means is configured to being operable by movement of an user's torso while seated in the seat, and wherein the said operating movement is a lateral leaning movement of the torso relative to the seat.

2. The wheelchair according to claim 1, wherein the actuation means comprises a back-rest of the wheelchair, the backrest being configured to tilt or rotate in a plane substantially perpendicular to a forward direction of travel of the wheelchair.

3. The wheelchair according to claim 2, wherein the back-rest is arranged to engage with the lumbar region of the user's back.

4. The wheelchair according to claim 2, wherein the back-rest comprises one or more projections (17, 18) for engaging with the user's torso.

5. The wheelchair according to claim 4, wherein the projections are arranged above a tilt axis of the back-rest.

6. The wheelchair according to claim 2, comprising an actuation linkage for converting the tilting or rotating movement of the back-rest to a steering movement of the one or more steerable wheels.

7. The wheelchair according to claim 2, wherein the actuation linkage comprises a push-pull cable (21) arranged such that a tilting of the back-rest in a first lateral direction pulls the push-pull cable, and a tilting of the back-rest in a second, opposite lateral direction pushes the push-pull cable.

8. The wheelchair according to claim 2, wherein the actuation linkage comprises two pull cables arranged such that a tilting of the back-rest in a first lateral direction pulls a first of the two pull cables, and a tilting of the back-rest in a second, opposite lateral direction pulls the other of the two pull cables.

9. The wheelchair according to claim 2, wherein the one or more steerable wheels are mounted on a steering bar which is pivotable about a steering axis, and wherein the actuation means is operable to pivot the steering bar.

10. The wheelchair according to claim 9, wherein the rotation axis of the or each steerable wheel is fixed with respect to the steering bar.

11. The wheelchair according to claim 9, wherein the or each steerable wheel (6) is pivotable as a castor with respect to the steering bar about a castor pivot axis, and wherein the pivoting of the steerable wheel is preventable by a locking means so that the orientation of the rotation axis of the steerable wheel is controllably fixable with respect to the steering bar.

12. The wheelchair according to claim 11, comprising user-operable locking control means for selectably actuating the locking means.

13. The wheelchair according to claim 1, comprising two propulsion wheels which are arranged to be manually rotated by the user and which are free to rotate independently of each other.

14. The wheelchair according to claim 13, wherein the one or more steerable wheels are forward of the propulsion wheels.

15. The wheelchair according to claim 1, wherein the actuation means and the steering are configured such that a tilt of the user's back in the range 3° to 10° is translated into a steering radius in the range 0.7 m to 5 m.
